(19) United States
(12) Patent Application Publication
(10) Pub. No.: US 2006/0187567 A1
(43) Pub. Date: Aug. 24, 2006

(54) Motor driver and magnetic disc apparatus

(76) Inventor: Mitsuaki Daio, Kyoto (JP)

Correspondence Address: FISH & RICHARDSON P.C., P.O. BOX 1022, MINNEAPOLIS, MN, 55440-1022, US

(21) Appl. No.: 10/561,300

(22) PCT Filed: Aug. 20, 2004
(86) PCT No.: PCT/JP04/11971

§ 371 Date: Dec. 15, 2005

(30) Foreign Application Priority Data
Aug. 21, 2003 (JP) 2003-297814

(51) Int. Cl. G11B 21/02; G11B 15/12

(52) U.S. Cl. 360/75; 360/61

(57) ABSTRACT

When the drive current fed to a VCM 3 is large, a driver D2 is turned on, and a driver D3 is turned off so that the current detected by a current detection amplifier A1 is fed back based on the voltage across a detection resistor RS1. When the drive current fed to the VCM 3 is small, the driver D2 is turned off, and the driver D3 is turned on so that the current detected by a current detection amplifier A2 is fed back based on the voltage across a detection resistor RS2.

### TECHNICAL FIELD

The present invention relates to a motor driver for driving a direct-current motor, and more particularly to a motor driver that detects the current flowing through a motor coil so as to determine the current in relation to the input voltage. The present invention also relates to a magnetic disk apparatus in which such a motor driver is used to control the driving of a magnetic head.

### BACKGROUND ART

A motor driver is used to control the current that flows through a direct-current motor such as a VCM (voice coil motor). Some motor drivers of this type, i.e., those which feed a drive current to a direct-current motor, are so configured as to detect the current flowing through the coil of the direct-current motor and perform feedback control. An example of such a configuration is found in a conventionally proposed VCM control unit (see Patent Publication 1 listed below). This VCM control unit includes: a sense resistor for detecting as a voltage the drive current of a VCM; and a sense amplifier for amplifying the voltage across the sense resistor and then feeding it back to the input side. In this way, by amplifying the voltage across a sense resistor with a sense amplifier and then feeding it back to the input side of a VCM driver circuit, it is possible to adjust the value of the drive current of a VCM.

Patent Publication 1: Japanese Patent Application Laid-open No. 2003-173640

### DISCLOSURE OF THE INVENTION

Problems to be Solved by the Invention

A conventional motor driver, like the control unit proposed in Patent Publication 1 mentioned above, is used as a driver for a VCM provided in a hard disk drive. The trend for increasingly high density hard disks demands increasingly high resolutions. This makes accordingly small the current that a VCM passes through a motor coil, for example, to drive a magnetic head to follow a track on a disk. Thus, the lower the resistance of a detection resistor for detecting the output current to the motor coil, the lower the detection accuracy of a detection amplifier. For this reason, it is necessary either to increase the gain of the current detection amplifier, which includes a differential amplifier circuit for amplifying the voltage across the detection resistor, or to increase the resistance of the detection resistor.

However, increasing the gain of the current detection amplifier or increasing the resistance of the detection resistor makes higher the output of the current detection amplifier relative to the input voltage fed to the VCM to control the driving thereof when, as during a seek operation, the magnetic head travels a large distance and thus a large current flows through the coil. As a result, when the current flowing through the coil is large, the range of the input voltage is narrow, and thus the range in which the driving of the VCM can be controlled is narrow. Moreover, increasing the resistance of the detection resistor makes larger the amount of heat generated when the current flowing through the coil is large.

In view of the conventionally encountered problems described above, it is an object of the present invention to provide a motor driver that can change, according to the magnitude of the current flowing through a motor coil, the resistance of a detection resistor for detecting the current, and to provide a magnetic disk apparatus incorporating such a motor driver.

Means for Solving the Problem

To achieve the above object, according to one aspect of the present invention, in a motor driver including a current output driver that outputs a drive current fed to a direct-current motor and a gain switch circuit that switches the current/voltage gain for the value of the drive current with respect to an input voltage is provided with: n detection resistors connected in series with the coil of the direct-current motor; n switches provided one for each of the n detection resistors, each switch having one end thereof connected to the end of the corresponding detection resistor farther from the coil, and having a predetermined direct-current voltage applied to the other end thereof; and n current detection amplifiers provided one for each of the n detection resistors, each current detection amplifier detecting the voltage across the corresponding detection resistor and feeding the detected voltage back to the gain switch circuit. Here the turning on and off of the switches is controlled according to the current/voltage gain switched by the gain switch circuit.

With this configuration, one of the switches is turned on and the value of the drive current for the direct-current motor with respect to the input voltage is adjusted based on the output of the current detection amplifier that detects the voltage across the detection resistor electrically connected to that switch. Here, the larger the drive current to the direct-current motor, the lower the resistance of the detection resistor the voltage across which is used for current detection. Moreover, the lower the resistance of a detection resistor, the closer to the coil of the direct-current motor it is provided.

According to another aspect of the present invention, in a motor driver including a current output driver that outputs a drive current fed to a direct-current motor and a gain switch circuit that switches the current/voltage gain for the value of the drive current with respect to an input voltage is provided with: a first detection resistor having one end thereof connected to the coil constituting the direct-current motor; a second detection resistor having one end thereof connected to the other end of the first detection resistor so as to be connected in series with the first detection resistor, the second detection resistor having a different resistance from the first detection resistor; a first switch having one end thereof connected to the node between the other end of the first detection resistor and the one end of the second detection resistor, the first switch having a predetermined direct-current voltage applied to the other end thereof; a second switch having one end thereof connected to the other end of the second detection resistor, the second switch having a predetermined voltage applied to the other end thereof; a first current detection amplifier that detects the voltage across the first detection resistor and feeds the detected voltage back to the gain switch circuit; and a second current detection amplifier that detects the voltage across the second detection resistor and feeds the detected voltage back to the gain switch circuit. Here, the turning on and off of the first and second switches is controlled according to the current/voltage gain switched by the gain switch circuit.

According to another aspect of the present invention, a magnetic disk apparatus is provided with: any of the motor drivers described above; the direct-current motor whose driving is controlled by the motor driver; and a magnetic head that is moved in the direction of a radius of the magnetic disk by being fed with mechanical power from the direct-current motor.

Advantages of the Invention

According to the present invention, which detection resistor to use can be switched, and thus the detection resistor for detecting the magnitude of the drive current can be selected according to the magnitude of the drive current fed to the direct-current motor. Consequently, irrespective of the magnitude of the drive current, the current detection amplifier can detect the drive current with high accuracy. This helps widen the usable output range of the drive current, and permits the driving of the direct-current motor to be controlled with high accuracy even when the drive current is feeble. Moreover, when the drive current is large, it is possible to select a detection resistor with a lower resistance and thereby reduce the heat generated by the detection resistor and thus the electrical power consumed thereby.

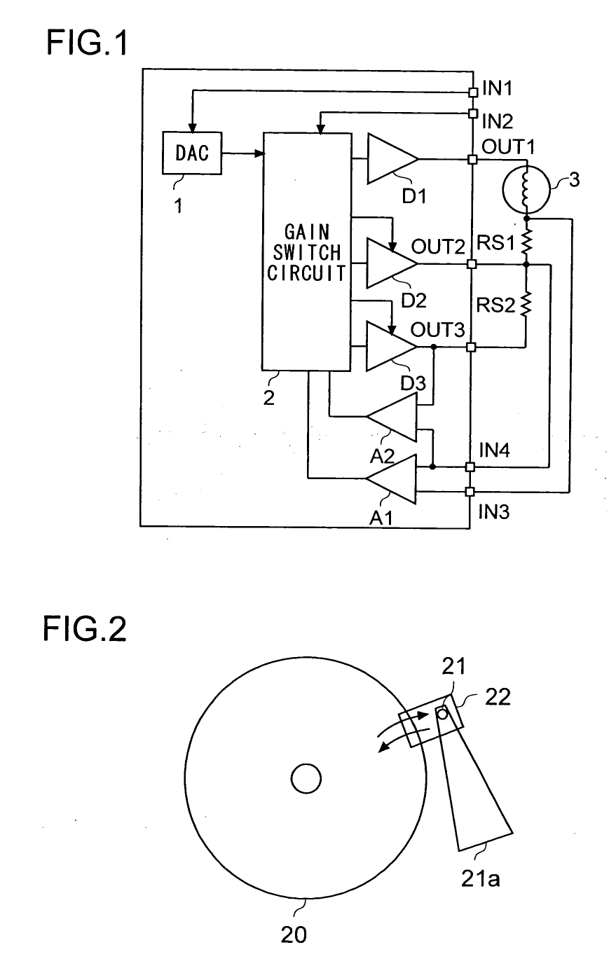

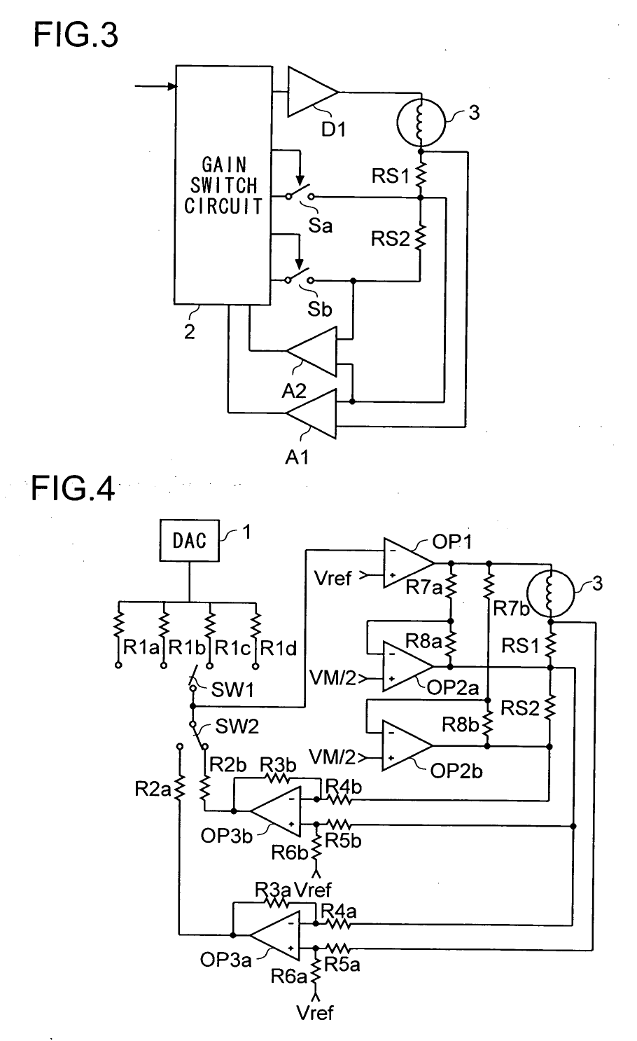

### BRIEF DESCRIPTION OF DRAWINGS

[FIG. 1] A block diagram showing a configuration of a motor driver according to the invention.

[FIG. 2] A diagram schematically showing an outline of the construction of a magnetic disk apparatus provided with the motor driver of FIG. 1.

[FIG. 3] An equivalent circuit diagram of the motor driver of FIG. 1.

[FIG. 4] A circuit diagram showing a circuit configuration of the motor driver according to the invention.

[FIG. 1] A block diagram showing another configuration of a motor driver according to the invention.

### LIST OF REFERENCE SYMBOLS

1 DAC

2 Gain Switch Circuit

3 VCM

D1 to D3 Drivers

A1, A2 Current Detection Amplifiers

RS1, RS2 Detection Resistors

### BEST MODE FOR CARRYING OUT THE INVENTION

Hereinafter, embodiments of the present invention will be described with reference to the drawings. FIG. 1 is a block circuit diagram showing the internal configuration of, as one embodiment, a motor driver built in a semiconductor integrated circuit device.

The semiconductor integrated circuit device shown in FIG. 1 includes: an input terminal IN1 via which is fed in a signal that determines the distance that the head is made to travel by a VCM 3; an input terminal IN2 via which is fed in a switch signal that varies the gain of the amplifier circuit including a driver D1; a digital-to-analog conversion circuit (DAC) 1 that performs digital-to-analog conversion on the signal fed in via the input terminal IN1; a gain switch circuit 2 that switches, according to the switch signal fed in via the input terminal IN2, the gain of the amplifier circuit including the driver D1; a current drive driver D1 that feeds the VCM 3 with a current commensurate with a voltage signal fed from the DAC 1 via the gain switch circuit 2; inverted current driving drivers D2 and D3 through which flows the current that has flowed through the VCM 3; current detection amplifiers A1 and A2 that detect the current flowing through the VCM 3 on the basis of the voltages across current detection resistors RS1 and RS2, respectively, connected in series with the VCM 3; output terminals OUT1 to OUT3 connected to the drivers D1 to D3, respectively; an input terminal IN3 that is connected to the node between the VCM 3 and the detection resistor RS1; and an input terminal IN4 that is connected to the node between the detection resistors RS1 and RS2.

In this semiconductor integrated circuit device, the drivers D2 and D3 are turned on and off by the gain switch circuit 2. The voltages across the detection resistors RS1 and RS2 are respectively fed to the current detection amplifiers A1 and A2 provided in the motor driver built in the semiconductor integrated circuit device so as to be amplified thereby, and are then fed back to the gain switch circuit 2. Here, the two inputs of the current detection amplifier A1 are connected to the input terminals IN3 and IN4, and the two inputs of the current detection amplifier A2 are connected to the input terminal IN4 and the output terminal OUT3. The resistances of the detection resistors RS1 and RS2 are so set that the resistance of the detection resistor RS2 is higher.

The output terminal OUT1 is connected to one end of the coil of the VCM 3, the output terminal OUT2 is connected to the node between the detection resistors RS1 and RS2, and the output terminal OUT3 is connected to the other end of the detection resistor RS2. Thus, when a large current is passed through the VCM 3 to perform an operation involving high-speed rotation, as when a magnetic head 21 as shown in FIG. 2 is made to perform a seek operation, current detection is performed on the basis of the voltage across the detection resistor RS1, which has the lower resistance. Incidentally, in a magnetic disk apparatus as shown in FIG. 2, the magnetic head 21 is moved in the direction of a radius of a disk 20 by being fed with mechanical power from the VCM 3 via a transmission member 21a. When the magnetic disk apparatus is out of operation, the magnetic head 21 rests in a ramp region 22 provided outside the disk 20.

In this case, the gain switch circuit 2 turns the driver D2 on and the driver D3 off, and thus the drive current outputted from the driver D1 flows via the coil of the VCM 3, then the detection resistor RS1, and then the output terminal OUT2 into the driver D2. The voltage across the detection resistor RS1 is amplified by the current detection amplifier A1, and is fed back to the gain switch circuit 2. The gain switch circuit 2 then adjusts the drive current by subtracting the voltage fed from the current detection amplifier A1 from the voltage fed from the DAC 1.

By contrast, when a feeble current is passed through the VCM 3 to perform an operation involving highly accurate rotation, as when the magnetic head 21 is made to follow a track on the disk 20, current detection is performed on the basis of the voltage across the detection resistor RS2, which has the higher resistance. In this case, the gain switch circuit 2 turns the driver D3 on and the driver D2 off, and thus the drive current outputted from the driver D1 flows via the coil of the VCM 3, then the detection resistors RS1 and RS2, and then the output terminal OUT3 into the driver D3. The voltage across the detection resistor RS2 is amplified by the current detection amplifier A2, and is fed back to the gain switch circuit 2. The gain switch circuit 2 then adjusts the drive current by subtracting the voltage fed from the current detection amplifier A2 from the voltage fed from the DAC 1.

In the motor driver configured as shown in FIG. 1, the drivers D2 and D3 act as switches for feeding the current flowing through the detection resistors RS1 and RS2 back to the gain switch circuit 2. Thus, the motor driver may be built with, instead of the drivers D2 and D3, switches Sa and Sb as shown in FIG. 3. Also with this configuration, the motor driver operates just as described above.

FIG. 4 shows a circuit configuration of the above-described motor driver built in a semiconductor integrated circuit device. The motor driver shown in FIG. 4 includes: a DAC 1; resistors R1a to R1d that are connected in parallel with one another and that receive, at one end, the voltage signal outputted from the DAC 1; a switch SW1 that selects electrical connection with the other end of one of the resistors R1a to R1d; a switch SW2 that is connected to the switch SW1; resistors R2a and R2b whose electrical connection with the switch SW1 is selected by the switch SW2; a differential amplifier OP1 whose inverting input terminal is connected to the node between the switches SW1 and SW2; a differential amplifier OP2a whose output terminal is connected to the node between the detection resistors RS1 and RS2; a differential amplifier OP2b whose output terminal is connected to the other end of the detection resistor RS2; and differential amplifiers OP3a and OP3b whose output terminals are connected to the resistors R2a and R2b, respectively.

The motor driver shown in FIG. 4 further includes: resistors R3a and R3b whose one ends are connected to the output terminals of the differential amplifiers OP3a and OP3b, respectively; resistors R4a and R4b whose one ends are connected to the other ends of the resistors R3a and R3b; resistors R5a and R6a whose one ends are connected to the non-inverting input terminals of the differential amplifier OP3a; resistors R5b and R6b whose one ends are connected to the non-inverting input terminal of the differential amplifier OP3b; resistors R7a and R7b whose one ends are connected to the output terminal of the differential amplifier OP1; and resistors R8a and R8b whose one ends are connected to the output terminals of the differential amplifiers OP2a and OP2b, respectively.

The node between the resistors R3a and R4a is connected to the inverting input terminal of the differential amplifier OP3a, and the node between the resistors R3b and R4b is connected to the inverting input terminal of the differential amplifier OP3b. The other end of the resistor R4a is connected to the node between the detection resistors RS1 and RS2, and the other end of the resistor R4b is connected to the node between the detection resistor RS2 and the output terminal of the differential amplifier OP2b. The other end of the resistor R5a is connected to the node between the detection resistor RS1 and the VCM 3, and the other end of the resistor R5b is connected to the node between the detection resistors RS1 and RS2. A direct-current voltage Vref is applied to the other ends of the resistors R6a and R6b.

The node between the other ends of the resistors R7a and R8a is connected to the inverting input terminal of the differential amplifier OP2a, and the node between the other ends of the resistors R7b and R8b is connected to the inverting input terminal of the differential amplifier OP2b. Assuming that the maximum and minimum levels of the voltage signal outputted from the DAC 1 are VM and zero, respectively, a direct-current voltage of ½VM is applied to the non-inverting input terminals of both the differential amplifiers OP2a and OP2b. The direct-current voltage Vref is fed to the non-inverting input terminal of the differential amplifier OP1.

In the motor driver configured as described above, the resistances of the detection resistors RS1 and RS2 fulfill the relationship RS1<RS2, the resistances of the resistors Ria to Rid fulfill the relationship R1a<R1b<R1c<R1d, and the resistors R2a and R2b fulfill the relationship R2a<R2b. When the switch SW1 electrically connects one of the resistors R1a and R1b to the inverting input terminal of the differential amplifier OP1, the switch SW2 electrically connects the resistor R2a to the inverting input terminal of the differential amplifier OP1, and turns the differential amplifier OP2b off. When the switch SW1 electrically connects one of the resistors R1c and R1d to the inverting input terminal of the differential amplifier OP1, the switch SW2 electrically connects the resistor R2b to the inverting input terminal of the differential amplifier OP1, and turns the differential amplifier OP2a off.

The resistances of the resistors R3a, R4a, R5a, and R6a fulfill the relationship R3a=R6a=K1×R4a=K1×R5a (where K1 is a constant), and the resistances of the resistors R3b, R4b, R5b, and R6b fulfill the relationship R3b=R6b=K2×R4b=K2×R5b (where K2 is a constant). Thus, the differential amplifier OP3a and the resistors R3a to R6a together form a current detection amplifier A1 with a gain of K1, and the differential amplifier OP3b and the resistors R3b to R6b together form a current detection amplifier A2 with a gain of K2. Here, the resistances of the detection resistors RS1 and RS2, the resistances of the resistors R2a and R2b, and the gains K1 and K2 are so set as to fulfill the relationship R2a/(K1×RS1)=R2b/(K2×RS2). The gains K1 and K2 fulfill the relationship K1>K2. The resistances of the resistors R7a and R7b are set equal, and the resistances of the resistors R8a and R8b are set equal.

This configuration works as follows. When, to perform a search operation, the magnetic head 21 is made to travel a large distance so as to move at high speed, the drive current to the VCM 3 needs to be increased so that the VCM 3 rotates at high speed. To achieve this, according to the switch signal, the switch SW1 selects one of the resistors R1a and R1b, and the switch SW2 selects the resistor R2a. Consequently, the input to the inverting input terminal of the differential amplifier OP1 is adjusted on the basis of the output from the differential amplifier OP3a, and thus adjustment is performed on the basis of the voltage across the detection resistor RS1.

In this case, according to the switch signal, the differential amplifier OP2a is turned on, and the differential amplifier OP2b is turned off. Thus, the drive current outputted from the differential amplifier OP1 first flows through the VCM 3, and then flows via the detection resistor RS1 into the differential amplifier OP2a. When the resistor Ria is selected, the current/voltage gain equals R2a/(R1a×RS1); when the resistor R1b is selected, the current/voltage gain equals R2a/(R1b×RS1).

By contrast, when, to make the magnetic head 21 follow a track, the magnetic head 21 is made to travel a small distance so as to move with high accuracy, the drive current to the VCM 3 needs to be decreased so that the VCM 3 rotates at low speed. To achieve this, according to the switch signal, the switch SW1 selects one of the resistors R1c and R1d, and the switch SW2 selects the resistor R2b. Consequently, the input to the inverting input terminal of the differential amplifier OP1 is adjusted on the basis of the output from the differential amplifier OP3b, and thus adjustment is performed on the basis of the voltage across the detection resistor RS2.

In this case, according to the switch signal, the differential amplifier OP2a is turned off, and the differential amplifier OP2b is turned on. Thus, the drive current outputted from the differential amplifier OP1 first flows through the VCM 3, and then flows via the detection resistors RS1 and RS2 into the differential amplifier OP2b. When the resistor R1c is selected, the current/voltage gain equals R2b/(R1c×RS2); when the resistor R1d is selected, the current/voltage gain equals R2b/(R1d×RS2).

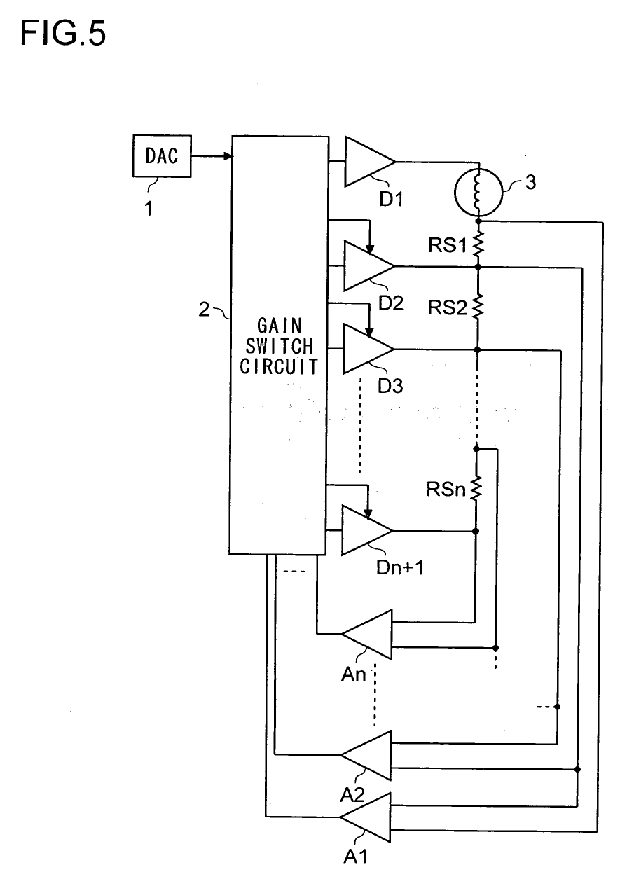

In this embodiment, the motor driver is provided with two detection resistors connected in series with the VCM 3 and two current detection amplifiers. Alternatively, as shown in FIG. 5, n detection resistors RS1 to RSn may be connected in series with the VCM. In this case, n drivers D2 to Dn+1 are provided to control the drive current having flowed through the VCM 3 to flow through the individual detection resistors RS1 to RSn, and current detection amplifiers A1 to An are provided to detect and amplify the voltages across the individual detection resistors RS1 to RSn.

It is also possible to adopt, although not illustrated, a configuration where n resistors are provided instead of the resistors R2a and R2b shown in FIG. 4 and one of them is selected by the switch SW2. In this configuration, the resistances RS of the detection resistors, the gains K of the current detection amplifiers, and the resistances R of the resistors corresponding to the resistors R2a and R2b shown in FIG. 4 are so set that the value of R/(K×RS) remains constant. Of all the drivers D2 to Dn+1, only one is turned on, and the other are kept off.

1. A motor driver including:
a current output driver that outputs a drive current fed to a direct-current motor; and
a gain switch circuit that switches a current/voltage gain for a value of the drive current with respect to an input voltage;
the motor driver comprising:
n detection resistors connected in series with a coil of the direct-current motor;
n switches provided one for each of the n detection resistors, each switch having one end thereof connected to an end of the corresponding detection resistor farther from the coil, and having a predetermined direct-current voltage applied to another end thereof, and
n current detection amplifiers provided one for each of the n detection resistors, each current detection amplifier detecting a voltage across the corresponding detection resistor and feeding the detected voltage back to the gain switch circuit;
wherein turning on and off of the switches is controlled according to the current/voltage gain switched by the gain switch circuit.

2. A motor driver including:
a current output driver that outputs a drive current fed to a direct-current motor; and
a gain switch circuit that switches a current/voltage gain for a value of the drive current with respect to an input voltage;
the motor driver comprising:
a first detection resistor having one end thereof connected to a coil constituting the direct-current motor;
a second detection resistor having one end thereof connected to another end of the first detection resistor so as to be connected in series with the first detection resistor, the second detection resistor having a different resistance from the first detection resistor;
a first switch having one end thereof connected to a node between the other end of the first detection resistor and the one end of the second detection resistor, the first switch having a predetermined direct-current voltage applied to another end thereof;
a second switch having one end thereof connected to another end of the second detection resistor, the second switch having a predetermined voltage applied to another end thereof;
a first current detection amplifier that detects a voltage across the first detection resistor and feeds the detected voltage back to the gain switch circuit; and
a second current detection amplifier that detects a voltage across the second detection resistor and feeds the detected voltage back to the gain switch circuit;
wherein turning on and off of the first and second switches is controlled according to the current/voltage gain switched by the gain switch circuit.

3. The motor driver of claim 2,
wherein, when the first switch is turned on, the second switch is turned off, and the gain switch circuit corrects the input voltage based on the voltage fed back from the first current detection amplifier, and
wherein, when the second switch is turned on, the first switch is turned off, and the gain switch circuit corrects the input voltage based on the voltage fed back from the second current detection amplifier.

4. The motor driver of claim 3,
wherein the gain switch circuit comprises:
a first resistor whose resistance is switchable, the first resistor receiving the input voltage at one end thereof and having another end thereof connected to an input side of the current output driver;
a second resistor receiving at one end thereof an output of the first current detection amplifier;
a third resistor receiving at one end thereof an output of the second current detection amplifier;
a third switch having three contacts, the third switch having one contact thereof connected to a node between the first resistor and the input side of the current output driver, the third switch having the other two contacts thereof connected respectively to another end of the second resistor and another end of the third resistor.

5. The motor driver of claim 4,
wherein, when the first switch is turned on, the third switch electrically connects the second resistor to the input side of the current output driver; and
wherein, when the second switch is turned on, the third switch electrically connects the third resistor to the input side of the current output driver.

6. The motor driver of claim 5,
wherein the following relationship is fulfilled:
R2a/(K1×RS1)=R2b/(K2×RS2)
where RS1 and RS2 represent resistances of the first and second detection resistors, respectively; R2a and R2b represent resistances of the second and third resistors, respectively; and K1 and K2 represent gains of the first and second current detection amplifiers, respectively.

7. The motor driver of claim 4,
wherein the following relationship is fulfilled:
R2a/(K1×RS1)=R2b/(K2×RS2)
where RS1 and RS2 represent resistances of the first and second detection resistors, respectively; R2a and R2b represent resistances of the second and third resistors, respectively; and K1 and K2 represent gains of the first and second current detection amplifiers, respectively.

8. The motor driver of claim 2,
wherein the gain switch circuit comprises:
a first resistor whose resistance is switchable, the first resistor receiving the input voltage at one end thereof and having another end thereof connected to an input side of the current output driver;
a second resistor receiving at one end thereof an output of the first current detection amplifier;
a third resistor receiving at one end thereof an output of the second current detection amplifier;
a third switch having three contacts, the third switch having one contact thereof connected to a node between the first resistor and the input side of the current output driver, the third switch having the other two contacts thereof connected respectively to another end of the second resistor and another end of the third resistor.

9. The motor driver of claim 8,
wherein, when the first switch is turned on, the third switch electrically connects the second resistor to the input side of the current output driver; and
wherein, when the second switch is turned on, the third switch electrically connects the third resistor to the input side of the current output driver.

10. The motor driver of claim 8,
wherein the following relationship is fulfilled:
R2a/(K1×RS1)=R2b/(K2×RS2)
where RS1 and RS2 represent resistances of the first and second detection resistors, respectively; R2a and R2b represent resistances of the second and third resistors, respectively; and K1 and K2 represent gains of the first and second current detection amplifiers, respectively.

11. The motor driver of claim 2,
wherein the current output driver, the gain switch circuit, the first and second switches, and the first and second current detection amplifiers are built as a single semiconductor integrated circuit device.

12. A magnetic disk apparatus comprising:
the motor driver of claim 1;
the direct-current motor whose driving is controlled by the motor driver; and
a magnetic head that is moved in a direction of a radius of a magnetic disk by being fed with power from the direct-current motor.

13. A magnetic disk apparatus comprising:
the motor driver of claim 2;
the direct-current motor whose driving is controlled by the motor driver; and a magnetic head that is moved in a direction of a radius of a magnetic disk by being fed with power from the direct-current motor.
